(19) United States
(12) Patent Application Publication
(10) Pub. No.: US 2011/0078230 A1
(43) Pub. Date: Mar. 31, 2011

(54) METHOD AND SYSTEM FOR PROVIDING A CDN WITH GRANULAR QUALITY OF SERVICE

(76) Inventor: Emilio Sepulveda, Barcelona (ES)

(21) Appl. No.: 12/567,010

(22) Filed: Sep. 25, 2009

(51) Int. Cl. G06F 15/16

(52) U.S. Cl. 709/203; 709/226; 709/219; 709/224

(57) ABSTRACT

In a method of providing granular quality of service in a hybrid content distribution network of classical distribution in a network via client-server plus very distributed mechanisms operating peer to peer inside the network, content is replicated in a large number of endpoint nodes, some of which are CPEs of broadband subscribers, and backed by a few storage servers to ensure content availability. Traffic is delivered by a mixture of P4P for choice of seeds and selection of good neighborhoods for quick content download. The ISP uses the unsold physical capacity of the link for CDN service and other underutilized resources, and enforces seeding at many nodes including broadband subscriber CPEs. By having a large farm of nano-datacenters distributed across the network, including the premises of broadband customers, the ISP can maintain and run a CDN. A tracker determines where to seed the content, depending on the number of broadband subscribers requesting the content, the geographical distribution of requested content, and the Service Level Agreement between content providers and the ISP. The tracker can seed a sufficient number of nodes to ensure redundancy.

### CROSS-REFERENCE TO RELATED APPLICATIONS

Not applicable.

### COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to the optimization of content distribution networks. More specifically, the invention relates to a system and method of providing granular quality of service in content distribution networks that target distribution of streaming video and other types of content, and support advanced non-linear play functions following a hybrid approach, that is, classical distribution in a network via client-server plus very distributed mechanisms operating peer to peer inside the network.

2. Definitions

The following abbreviations and definitions are used herein:

appTracker: a tracker whose functionality is ensuring that (1) a requesting peer can find a neighborhood of peers from whom he or she can download content; (2) a requesting peer can find other peers in its neighborhood at the same play-point in response to forward/backward DVD operations; (3) a peer has a healthy neighborhood of peers from whom to download data and download from the server only as a last resort; and (4) the tracker implements P4P so it will preferentially select local peers.

BitTorrent: a popular, distributed form of peer-to-peer file sharing that enables a client program to fetch different parts of a file (a “torrent”) from different sources in parallel. The system is designed to encourage broadband customers to make downloaded data available for others to upload. This is aided by a scheme for exchanging unique identifiers, commonly stored in “.torrent” files.

Cloud computing: any situation in which computing is done in a remote location (“out in the clouds”), rather than on a broadband customer's desktop or portable device. Cloud computing includes not only “remote” computing, but also “unspecified resources,” that is, any computing task commended to the cloud can be performed by any set of machines, and the identity of the machines in the set is not important to the machine that receives the results of the task.

Content Delivery Service Provider (CDSP): a global network that provides faster delivery of Web pages and media objects over the Internet. Using servers stationed around the world with duplicate content, the server closest to the broadband customer's request is the one that responds. In some cases, the text of the page is maintained on the customer's Web site, and only the graphics and other heavy media objects (i.e., video, audio, etc.) are distributed on the CDSP servers, since they are the most time-consuming part of the download. A CDSP or “edge” network can reduce the distance these elements travel from 20 to 30 hops (links between two network nodes) down to 3 or 4.

Content Distribution Network (CDN): a system of computers networked together across the Internet that cooperate transparently to deliver content (media objects) to end users (i.e., broadband customers), most often for the purpose of improving performance, scalability, and cost efficiency. A content source must “plug into” the CDN in order to make the content available at the edges of the CDN. Two modes of consuming media are distinguished: downloads and streams. Web pages (including those with dynamic content) and recorded videos can be made available to broadband customers as downloads. Live video events are better served to broadband customers as streams. Any pre recorded video can be served as a download or as a stream. Content delivery modes (downloads and streams) vary in implementation and availability from CDN to CDN.

Customer premises equipment (CPE): any piece of equipment with storage, computing, and communication capability that resides in the broadband customer's premises, including, but not limited to: a set-top box, a router/modem, a nano-datacenter (either standalone or integrated with one or more of router/modem, PC, a game console). Generally, there is only one CPE per broadband customer premises or home, as broadband resources are limited.

Data integrity: the quality of correctness, completeness, wholeness, soundness and compliance with the intention of the creators of the data. It is achieved by preventing accidental or deliberate but unauthorized insertion, modification or destruction of data in a database.

DNS: abbreviation for Domain Name Server.

Edge computing: provides application processing load balancing capacity to corporate and other large-scale web servers. It is analogous to an application cache, where the cache is in the Internet itself

Edge network: a network provided by a content delivery service provider that operates close to the end user (broadband customer) in terms of network distance. This usually implies deploying servers on the ‘last mile’ that is co-located to the first aggregation point of the user traffic. This is the reason for calling it edge of the network.

Granularity: The extent to which a system itself, or its description or observation, is broken down into small parts; or the degree of modularity of a system. Coarse-grained systems consist of fewer, larger components or modules than fine-grained systems.

ISP: Internet Service Provider.

iTracker: an Access Portal that includes a database with network topology and geo-location information, ISP policies and guidelines including protocol and applications, an interface that allows content providers to allocate ISP's resources, a Query Engine that will return different information depending on the application, and IP geographical location, route selection info, and peer clusters.

iTracker allows different services for different broadband customer profiles. iTracker for ISPs provides ISPs with access to their data (geo-location) for the other services. iTracker for ad providers (for example, Google) provides Geo-Location info (allowing ad providers to serve better targeted contents/ads). iTracker for Content Providers: provides Booking resources for content distribution.

Latency (also referred to as “network latency”): The time between initiating a request in the computer and receiving the answer. Network latency is the delay introduced when a packet is momentarily stored, analyzed and then forwarded.

Media Object: A portion of one or two elements that may contain video and/or audio. Media objects with audio are normally synchronized with the video when used at the same time.

Multihomed: Typically used to describe a host connected to two or more networks or having two or more network addresses. For example, a network server may be connected to a serial line and a LAN or to multiple LANs.

Nano-datacenter (NADA): A single computing resource with storage, computing and communication capability, but with the sole purpose of acting as a part of a distributed CDN. By enabling a distributed hosting infrastructure, NADAs are expected to enable the next-generation of interactive services, distributing data efficiently and working by complementing existing data centers. NanoDatancenters also allow cloud computing services by providing computing capabilities. Nano datacenters can be deployed into CPEs or into an ISP network.

NanoPoP: the smallest entity that can provide service to others without any service provider specific infrastructure deployed in it, which can be equipment in the premises of a broadband customer that provides storage, communications, and computational capabilities. A nanoPoP can also be a non-telephone-company specific device hosted by the ISP at the edge of the network; an end user PC running the service provider software, a dedicated device; or other equipment with similar storage, communications, and computational capabilities. The nanoPoP (or the software providing communications and computational capabilities in the case of the end user PC) is controlled by the service provider tracker.

Neighborhood: a set of peers close in terms of network distance (i.e., having a direct link or a reduced hop count) to a client requesting content. Peers in a neighborhood need not be close in geographic terms, but may be close in network terms if they have a direct link or the hop count is reduced.

Peer-to-peer (P2P): distributed systems consisting of interconnected nodes able to self-organize into network topologies with the purpose of sharing resources such as content, CPU cycles, storage and bandwidth, capable of adapting to failures and accommodating transient populations of nodes while maintaining acceptable connectivity and performance, without requiring the intermediation or support of a global centralized server or authority Unlike a client-server model where some nodes function exclusively as clients and others as servers, a P2P network is made of nodes that function as both “clients” and “servers” to other nodes in the network.

Peer: also referred to as a P2P client, a member of a P2P network to which another member can connect and transfer data. Usually a peer does not have the complete shared resource (which may be a file or a stream), but only parts of it. Together, all peers (including the ones called ‘seeds’) sharing a resource are called a swarm.

Point of Presence (PoP): the point at which a line from a long distance carrier (interexchange carrier or “IXC”) connects to the line of the local telephone company or to the broadband customer if the local company is not involved. For dial-up access to the Internet via analog modem, the PoP is the local telephone exchange that the modem dials into to log in.

Provider Portal for P2P Applications (P4P): also known as Proactive network provider Participation for P2P, a framework for optimizing peer-to-peer connections by allowing explicit and seamless communications between ISPs and P2P applications. The P4P architecture prefers local connections over remote ones, and therefore is expected to reduce transit cost for ISPs and reduce download times for broadband customers.

pTracker: Another name for an appTracker.

Quality Of Service (QoS): a defined measure of performance in a data communications system. For example, to ensure that real-time voice and video are delivered without annoying blips, a traffic contract is negotiated between the broadband customer and the network provider that guarantees a minimum bandwidth along with the maximum delay that can be tolerated in milliseconds.

Seed: in a distributed form of peer-to-peer file sharing, such as BitTorrent, a peer that has a complete copy of a torrent file, possibly the original, and is able to offer it for upload.

Seeding: the pre-provisioning of content to some network nodes before there is actual demand. In a complex distributed network, comprising many nodes, seeding is often handled through semi-autonomous agents, in contrast to the way it is handled in a pure P2P network (in which the end user decides what to seed). In this case, seeding is started by the source (the semi-autonomous agents) giving seeding orders to only a portion of the network nodes (peers or agents)—the nodes in direct contact with the source—and letting them proceed with some “seeding mission,” without actually knowing the full list of agents in the network and without real time control of the number of nodes seeded. In this context, “seeding” the content in the network is sometimes referred to as “enforced seeding” or “seeding enforcement” because seeding takes place semi-autonomously; that is, the original source merely started the seeding process and then in some way “enforced” it. As “seed” accurately describes the concept of starting a semi-autonomous process that has a much larger impact than would be possible if carried out by the original source alone, “seeding” is used herein rather than “enforced seeding” or seeding enforcement.”

Service latency: The total amount of time elapsed from user request to user receiving response in that service. Service latency relates in a complex manner to network latency, processing latency, and many other latencies and circumstances.

Throughput (also referred to as network throughput): In communication networks, such as Ethernet or packet radio, throughput or network throughput is the average rate of successful message delivery over a communication channel. These data may be delivered over a physical or logical link, or pass through a certain network node. The throughput is usually measured in bits per second (bit/s or bps), and sometimes in data packets per second or data packets per time slot. Throughput is essentially synonymous with digital bandwidth consumption.

Time-to-live (TTL) is a limit on the period of time or number of iterations or transmissions in computer and computer network technology that a unit of data (e.g., a packet) can experience before it should be discarded.

Torrent file: a file that contains data relating to the location of files and computers in a distributed, peer-to-peer file sharing network.

Tracker: a server that keeps track of which seeds and peers are in a swarm.

VPN: abbreviation for Virtual Private Network.

3. Related Art

In a traditional CDN, content is pushed to the edge of the network, from where it is served by the owner of the CDN. Content distribution follows a client-server model. The CDN service providers offer content hosting service for the content creators. As a result, the CDN service provider has to host and run servers, network and storage equipment on behalf of its clients. For a CDN owner, it is expensive to maintain and run servers and storage equipment in different parts of the world.

Also in a traditional CDN model, there are a number of PoPs (input, storage and distribution) around the world and content is stored in the PoPs. Traffic routing is known and decided by the owner of the CDN. This routing is decided overlaid on (that is, without taking into account) the underlying, actual physical network. This approach to routing can cause some headaches for the network owners. As a result, the CDN pop can be, for example, in Amsterdam while the content consumer is in Stockholm, and the content goes through New York due to the network layout. This international routing happens more often in P2P networks, but also may happen in traditional CDNs. Content is pushed up to the edge of the CDN. The CDN provides QoS based on latency and throughput.

Demand for Internet content is composed of micro-flows, which come from all over the world, and has increased dramatically over time. P2P applications are responsible for up to 60-70% of Internet traffic. Random peering (e.g., BitTorrents) causes traffic spread across PoPs and domains because P2P is unaware of the physical layer. This traffic pattern causes problems—including increased network resource usage (e.g., using bandwidth of more links), increased network operational costs, and degraded performance of other applications—for ISP and broadband customers.

According to the website of the Yale P4P Project, http://codex.cs.yale.edu/avi/home-page/p4p-dir/p4p.html, Peer-to-Peer (P2P) is emerging as a major paradigm for developing networked applications. However, the wide spread of P2P applications also exposes a fundamental issue in current network management and control. Current P2P information exchange schemes are “network-oblivious” and use intricate protocols for tapping the bandwidth of participating broadband customers to help move data. ISPs try to “manage” P2P traffic by upgrading network infrastructure, deploying P2P caching devices, terminating connectivity, and rate-limiting P2P traffic. In response, P2P tries to evade capture by using random ports and encrypting traffic. The existing schemes therefore are often both inefficient and costly.

Emerging P2P applications can have tremendous flexibility in how the data is communicated. Thus, they should be an integral part of network management and control. However, if end hosts are to participate in network resource optimizations, then the networks cannot continue to be opaque but need to export their status and policy information.

The objective of P4P is to have an open architecture in which any ISP (Internet Service Provider) and any P2P can participate. The P4P architecture allows explicit and seamless communications between network providers (i.e., ISPs) and P2P applications. It has the potential for making the Internet work more efficiently, in that ISPs and P2P software providers can work cooperatively to deliver data. FIG. 1 is a comparison of a traditional CDN, a P2P network, and a P4P network, showing how P4P enables efficient delivery relative to CDN and P2P.

The P4P framework consists of a control-plane component and a data-plane component. In the control plane, P4P introduces iTrackers to provide portals for P2P to communicate with network providers. The introduction of iTrackers allows P4P to divide traffic control responsibilities between P2P and providers, and also makes P4P incrementally deployable and extensible.

Specifically, each network provider, be it a conventional commercial network provider (e.g., AT&T), a university campus network, or a virtual service provider (e.g., Akamai), maintains an iTracker for its network. A P2P client obtains the IP address of the iTracker of its local provider through a DNS query (with a new DNS record type P4P). Standard techniques can be applied to allow for multiple iTrackers in a given domain, especially for fault tolerance and scalability. The iTracker provides a portal for three kinds of information regarding the network provider: network status/topology; provider guidelines/policies; and network capabilities.

In the data plane, P4P allows routers on the data plane to give fine-grained feedback to P2P and enable more efficient usage of network resources. Specifically, routers can mark the Explicit Congestion Notification (“ECN”) bits of Transmission Control Protocol (“TCP”) packets (or a field in a P2P header), or explicitly designate flow rates using eXplicit Congestion control Protocol (“XCP”)-like approaches. End hosts then adjust their flow rates accordingly. For instance, a multihomed network can optimize financial cost and improve performance through virtual capacity computed based on 95-percentiles. When the virtual capacity is approached, routers mark TCP packets and end hosts reduce their flow rates accordingly; thus the network provider can both optimize its cost and performance and allocate more bandwidth to P2P flows. The data plane component is optional and can be incrementally deployed.

FIG. 2 illustrates the potential entities in the P4P framework and the interactions between them. The potential entitles are: iTrackers owned by individual network providers, appTrackers in P2P systems, and P2P clients (peers). Not all entities might interact in a given setting. For example, trackerless systems do not have appTrackers in this case. Instead, the distributed application itself acts as a tracker; and the shared state of all the peers is used to track the behavior of any one of them. P4P does not dictate the exact information flow, but rather provides only a common messaging framework, with control messages encoded in XML for extensibility.

The iTrackers have three interfaces: the info interface, the policy interface, and the capability interface. A network provider may choose to implement a subset of the interfaces. The richness of information conveyed is also determined by the network provider. A network provider can also enforce some access control to the interfaces to preserve security and privacy.

The info interface allows others, typically peers inside the provider network, to obtain network topology and status. Specifically, given a query for an IP address inside the network, the interface maps the IP address to a (ASID, PID, LOC) tuple, where ASID is the ID of the network provider (e.g., its AS number), PID is an opaque ID assigned to a group of network nodes, and LOC is a virtual or geographical coordinate of the node. The opaque PID is used to preserve provider privacy at a coarse grain (e.g., a network provider can assign two PIDs to nodes at the same point of presence or PoP). LOC can be used to compute network proximity, which can be helpful in choosing peers. When sending an info query, a peer may optionally include its swarm ID (e.g., info hash of a torrent). The iTracker may keep track of peers participating in a swarm.

The policy interface allows others, for example peers or appTrackers, to obtain policies and guidelines of the network. Policies specify how a network provider would like its networks to be utilized at a high level, typically regardless of P2P applications; while guidelines are specific suggestions for P2P to use the network resources. To name a few examples of network policies: (1) traffic ratio balance policy, defining the ratio between inbound and outbound traffic volumes, for interdomain peering links; (2) coarse-grain time-of-day link usage policy, defining the desired usage pattern of specific links (e.g., avoid using links that are congested during peak times); and (3) fine-grain link usage policy. An example of network guidelines is that a network provider computes peering relationships for clusters of peers (e.g., clustered by PID). The policy interface can also return a set of normalized inter-PID costs, which indicate costs incurred to the provider when peers in two PIDs communicate.

The capability interface allows others, for example peers or content providers (through appTrackers), to request network providers' capabilities. For example, a network provider may provide different classes of services or on-demand servers in its network. Then an appTracker may ask iTrackers in popular domains to provide such servers and then use them as peers to accelerate P2P content distribution.

However, if end hosts are to participate in network resource optimizations, then the networks cannot continue to be opaque but need to export their status and policy information. As a result, P4P allows explicit communications between network providers and applications.

The P4P architecture is illustrated schematically in FIG. 3. Using BitTorrent in a single ISP as an example, a pTracker runs the P2P system, and an iTracker makes suggestions for peering relationships. The information flow is a follows: (1) peer queries pTracker; (2) pTracker asks iTracker for guidance (occasionally); (3) iTracker returns high-level peering suggestions; and (4) pTracker selects and returns a set of active peers, according to the suggestions. iTracker can be run by trusted third parties, P2P network, or ISP's.

For P2P providers, P4P will provide a better user experience by optimizing download times, potentially suppressing existing caps in the ISPs, and allowing ISPs to aggregate servers that will be considered in the P4P logic and will accelerate downloads.

For ISPs, the exchange of information between P2P and ISP under P4P can mitigate the load on ISPs by delivering traffic more intelligently. P4P also will bring the opportunity to reduce the IP transit cost and allow the launch of service that could give class of service, or quality of service that a P2P content provider can request. Nonetheless, the P4P architecture does not provide granular quality of service.

It is to the solution of this and other problems that the present invention is directed.

### SUMMARY OF THE INVENTION

It is accordingly a primary object of the present invention to tap into the underutilized resources at the edges of the network and use them in the “cloud” arena as a substitute/aid to expensive monolithic data centers to meet increasing content demand.

These and other objects are achieved by a content distribution network (CDN) model that relies on utilization of resources distributed finely throughout the network. The CDN model can, but does not have to use, resources at some premises close to end users, like the DSLAM premises; and thus becomes a hybrid CDN using both P2P and dedicated resources when required. The content is replicated in a large number of network (storage) nodes (which can equally well be nodes in the ISP realm, and CPEs) close to or directly placed at the premises of broadband customers (which can be corporate or residential users) and backed by a few storage servers to ensure content availability. Traffic is served by a mixture of P4P for choice of seeds (to ensure locality by preferring local seeds) and selection of good neighborhoods for quick content download.

ISPs sell bandwidth asymmetrically, providing more bandwidth downstream than upstream. However, the physical link that joins the broadband customer to the ISP usually has reserve capacity. In the CDN model in accordance with the present invention, the ISP uses the otherwise unsold physical capacity of the link between the ISP and the broadband customer's premises, as well as other underutilized resources, for CDN service; seeds client CPEs, if necessary; and can ensure quality-of-service (QoS) on a per-client basis. The granular QoS is provided to the content provider and the broadband customer consuming the content, and is done by ensuring a certain number of seeds in a certain geographic area (or zone) and other resources. By having a large farm of nano-datacenters (which can include nodes at the premises of the broadband customers) distributed across the network (each of which may or may not be owned by the ISP), the ISP can maintain and run a CDN.

The CDN is the whole sum of servers, topology servers, trackers, cooperating nanoPoPs and involved CPEs. Some portion of the CDN as a whole comprises completely conventional resources, such as web servers that replicate content providers' web sites (thus “proxying’ those web sites). These conventional resources are used at the CDN operator's discretion. The improvements of this very distributed CDN, provided in accordance with the present invention, rely on acting over more conventional resources when no distributed resources are available and at all times, rely on advanced, finely distributed resources when the conventional ones are impractical. The planning and optimization of the allocation of these resources is made by the CDN through the algorithms described herein.

The nanoPoPs run the CDN functions: storing and forwarding content in an intelligent way. The specific locations of the nanoPoPs into the network is not essential to the invention, as long as they are in the edge. Among the most notable properties of the nanoPoPs are that they are extremely lightweight and they are extremely easy to deploy in network nodes, so a pervasive deployment is pursued. In accordance with the present invention, ISP-owned nodes can run nanoPoPs at the same time CPEs can also run nanoPoPs.

A tracker determines where to seed the content depending on the number of clients requesting the content and the geography of requested content and the Service Level Agreement (“SLA”) between content provider and the ISP. The tracker can seed a sufficient number of nodes to ensure redundancy.

Other objects, features and advantages of the present invention will be apparent to those skilled in the art upon a reading of this specification including the accompanying drawings.

### BRIEF DESCRIPTION OF THE DRAWINGS

The invention is better understood by reading the following Detailed Description of the Preferred Embodiments with reference to the accompanying drawing figures, in which like reference numerals refer to like elements throughout, and in which:

FIG. 1 is a block diagram illustrating the potential entities in the P4P framework and the interactions between them.

FIG. 2 illustrates the potential entities in the P4P framework and the interactions between them.

FIG. 3 is a schematic illustration of the P4P architecture.

FIG. 4 is a schematic illustration showing content consumption in accordance with the present invention.

FIG. 5 is a schematic illustration showing content seeding in accordance with the present invention.

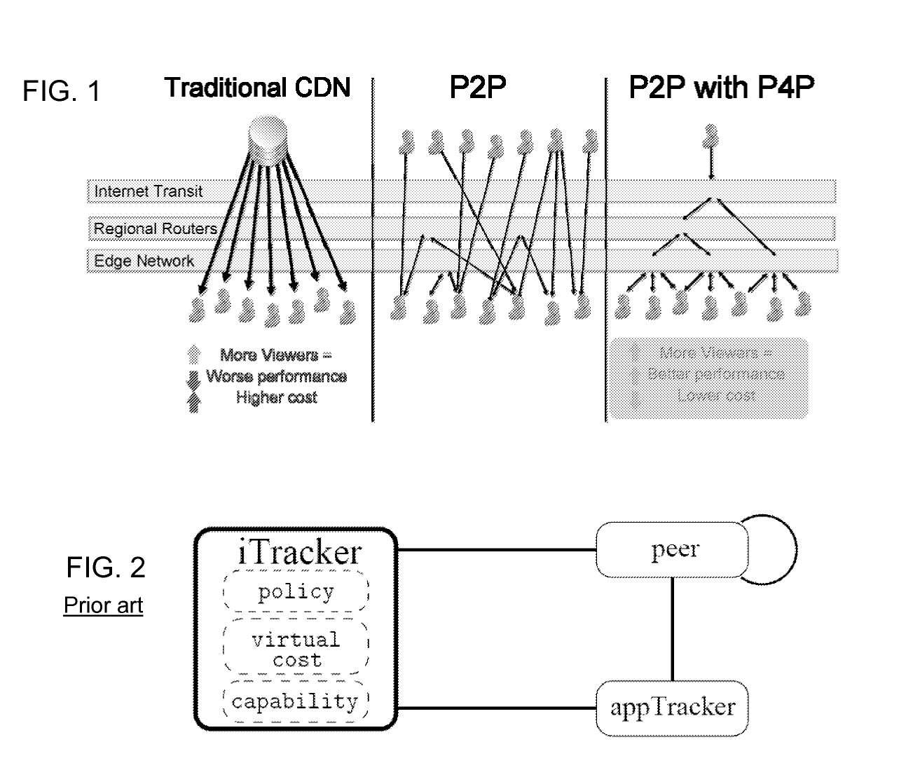

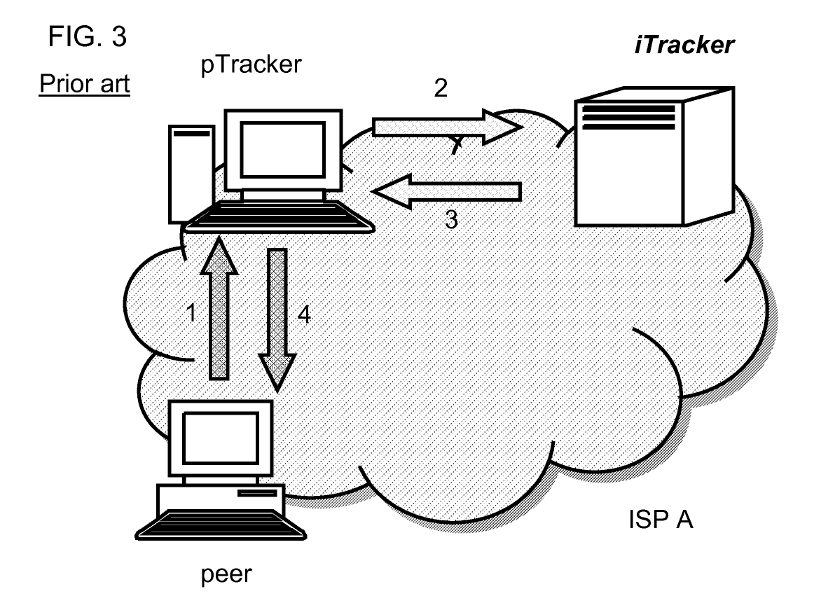

### DETAILED DESCRIPTION OF THE PREFERRED EMBODIMENTS

In describing preferred embodiments of the present invention illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose.

The present invention is described below with reference to flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

The present invention is preferably practiced within a client/server programming environment. As is known by those skilled in this art, “client/server” is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or and Extranet, as well. The term “computer network” shall incorporate publicly accessible computer networks and private computer networks.

The content distribution network (CDN) in which the present invention is employed follows a hybrid model, where hybrid means being able to use a client server mode and at the same time a peer to peer mode of transference, thereby relying on the usage of many distributed, lightweight resources, some of which can be the property of broadband customers. Content is stored (seeded) at and distributed from the edge of the network, at storage nodes or nanoPoPs that can be placed at the premises of broadband customers or into the ISP-owned nodes, or both, and replicated as many times as necessary to ensure content availability. Content is also backed by a few storage servers to ensure content availability.

The CDN has many distributed resources, each of which has some storage and some computing power. The CDN also has some machines (called “trackers”) that account for resources and (through commands) coordinate resources. Content is “seeded” or distributed to these resources using some appropriate algorithms that try to maximize utilization of resources, and minimize network transactions and aggregated throughput needed. When an end user needs to be served, the CDN's trackers are used to “plan” which resources (that is, which network nodes) will cooperate. There are three subsets of network node equipment: (1) devices located within the ISP network (ISP nodes); (2) CPEs located in the broadband customer's or corporate customer's premises; and (3) mobile devices. Depending on the environment in which they are used, videogame consoles can be classified as CPEs or mobile devices. Television sets connected to Internet can be classified as CPEs. Any other device with storage, computing, and communication capabilities can typically be classified as CPEs, and some of these devices can also be used in a mobile environment, and thus can be classified as mobile devices.

The resource planning is followed by some “acting” on the resources: the trackers send coordinating commands to the resources so the end user gets service from them. In this process of selecting resources and placing the appropriate commands, P4P topology information is used to make decisions based on the location of resources and the location of the end user who demands service. Apart from topology information, the method in accordance with the present invention uses advanced algorithms (disclosed in International Application No. PCT/EP2009/059497, filed Jul. 23, 2009) to select the best possible neighborhood for a given end user based on the real time state of resources, including load, pieces of content available, and prediction of user behavior.

The CDN provides quality-of-service (QoS) through the mechanisms of intelligent seeding (that is, applying seeding strategies that take into account as much information from the environment as possible, including the ISP's forecasts for content demand in some zones and also the CDN customer's (that is, the company requesting content distribution) forecasts about and knowledge of end users), intelligent distribution of effort and traffic among available nodes, advanced algorithms for neighborhood handling (which are well-known and are part of the state of the art), and the use of unsold upstream bandwidth and other underutilized resources. These mechanisms have a positive effect on throughput and service latency, the measurable QoS parameters that are relevant to end users (broadband customers).

More specifically, the ISPs use unsold physical capacity of the link that joins the broadband customer to the ISP for CDN service, and other underutilized resources, and seeding at broadband customer CPEs, if necessary, to ensure quality-of-service (QoS) on a per-broadband customer basis. These other underutilized resources include, but are not limited to, existing caching devices in the ISP network or in CPEs that are owned by the ISPs, as well as resources belonging to corporate customers that are not being used at certain point in time, for example, at night (the use of corporate customer resources normally will require a contractual relationship between the CDN and the corporate customer). By having a large farm of nano-datacenters distributed across many network nodes (each of which may or may not be owned by the ISP), the ISP can maintain and run a CDN.

NanoPoPs, the tiniest resources having storage plus computing capabilities, can be deployed in a finely distributed manner throughout the network or, in the alternative, a certain number of them can be aggregated in a single place. There are various reasons for grouping nanoPoPs in a single place, including reasons that prevent their distribution. For example, there may be some special network topology in which service should be concentrated in a network segment, making it impossible to distribute service elements; or there may be difficulties in deploying nanoPoPs in CPEs. Aggregations of nanoPoPs in the network benefit from the same design principles of fully distributed nanoPoPs: they are still very simple to handle, they are still controlled by trackers, they are disposable at any time, and they are very good performers. The only important difference introduced in this type of deployment is that trackers have to coordinate the efforts of all the aggregated nanoPoPs, taking into account that all of them are placed in the exact same location. This coordination can be done using the topology information available to trackers.

Data Integrity at the CPE:

To ensure the integrity of data from the content providers, one of several possible, conventional mechanisms can be used. These mechanisms are:

(1) Associating a time-to-live with content at the storage nodes, to prevent tampering at nodes when they are deployed on CPEs.

(2) Ensuring that when seeding, a complete file is not stored at any location (thus ensuring that it is impossible for the owner of a CPE to recover the complete file for content in clear format and tamper with it or extract it from the service for other purposes).

(3) Using conventional encryption algorithms.

Depending on the region and the size of the population served, the appTracker can either be centralized (a single tracker) or distributed. In a distributed setting, each appTracker can serve broadband customers in the same geographic area (or zone). However, the appTrackers can communicate with one another to exchange information about seeds, numbers of clients served by each seed, type of content, identification of the content and any associated statistical information. The present invention does not contemplate or require any specific implementation of the appTracker.

The appTrackers can use conventional, well-known techniques (some of them related to P4P) or proprietary techniques for exchanging messages with the peers about content. Proprietary techniques may be particularly useful to achieve higher performance than conventional techniques (for instance with respect to neighborhood handling, intelligent seeding, or progressive seeding).

Bundling of the CDN Service by the ISP and Ensuring Seeding at Broadband Customer Premises:

ISPs sell bandwidth asymmetrically, providing more bandwidth downstream than upstream. However, the physical link still has reserve capacity, and there is upstream bandwidth that is potentially available (i.e., “latent”) but not being sold. This “latent” upstream bandwidth is used to maximize the throughput of the whole CDN. There are several conventional mechanisms for using “latent” upstream bandwidth to maximize throughput, including opening completely the upstream bandwidth and capping the newly-available capacity for all the applications but the CDN, or establishing a VPN between the CPE and the ISP through the broadband access. For example, some bandwidth can be spared by constituting a VPN channel between the CPE and the ISP, with a given priority, so the CDN has a guaranteed bandwidth, irrespective of other uses of the broadband access (that is, the CDN as a whole benefits from the use of the “extra” bandwidth, so the entity managing the CDN can offer better performance of the content delivery service).

The latent upstream bandwidth can be put into production through different mechanisms, either at the CPE level or the at the broadband (DSL/cable or other broadband technology) equipment level, by establishing a VPN connection from the broadband customer premises to the Internet for the CDN application or uncapping the remaining unsold upstream capacity for the CDN application. The centralized decision maker (appTracker) uses P2P (including P4P enhancements)-like mechanisms or proprietary mechanisms (such as the “Apollo” application developed by Telefonica Research, described in International patent application No. PCT/EP2009/058970, filed Jul. 14, 2009, and in S. Siganos et al, “APOLLO: Network Transparency through a Pirate's Spyglass,” under preparation (2009), http://research.tid.es/georgos/images/apollo_client.pdf, both of which are incorporated herein by reference in their entireties) to “know” in real time what bandwidth is actually available at each broadband access; and can make routing decisions accordingly. The Apollo application is also used to modify locality decisions in P4P when the network has a high vacancy (i.e., valley time) and the hop count is not particularly relevant.

The ISPs use one of the following conventional techniques to bundle CDN service.

Let P be the physical capacity of the broadband customer link. Let C be the capacity that the broadband customer has purchased from the ISP (clearly, P>>C).

(1) The difference between the physical capacity and the purchased bandwidth (P−C) can be used to provide the CDN service on the broadband customer uplink.

(2) If a broadband customer purchased capacity C, but at a time t is using only Cu(t) (where Cu(t)<C), the free capacity (P−Cu(t)) can be used towards CDN service. However, up to C−Cu(t) bandwidth can be reclaimed by the broadband customer for other applications as needed at time t. This technique is used for those broadband customers downloading content from the CDN at a given moment in time t, but not for those acting as CDN seeds.

(3) If a broadband customer has purchased a capacity C, but is using only Cu(t) (where Cu(t)<C), the difference (C−Cu(t), the free capacity) can be used to provide the CDN service. However, the ISP provides a mechanism that allows a broadband customer to recapture the free capacity if needed by other applications. In this case, the ISP does not use the free physical capacity (P−C). A downside of using this technique is that the ISP is able to provide only a best effort service for the CDN service, because it relies on instantaneous usage patterns of a broadband customer. As with technique (2), this technique is used for those broadband customers downloading content from the CDN at a given moment in time t, but not for those acting as CDN seeds.

Such a scheme can be implemented with a two-queue mechanism, one queue for the broadband customer and the other queue for the CDN service. The CDN queue is processed only after the user queue is empty or it is non-empty and Cu(t)=C.

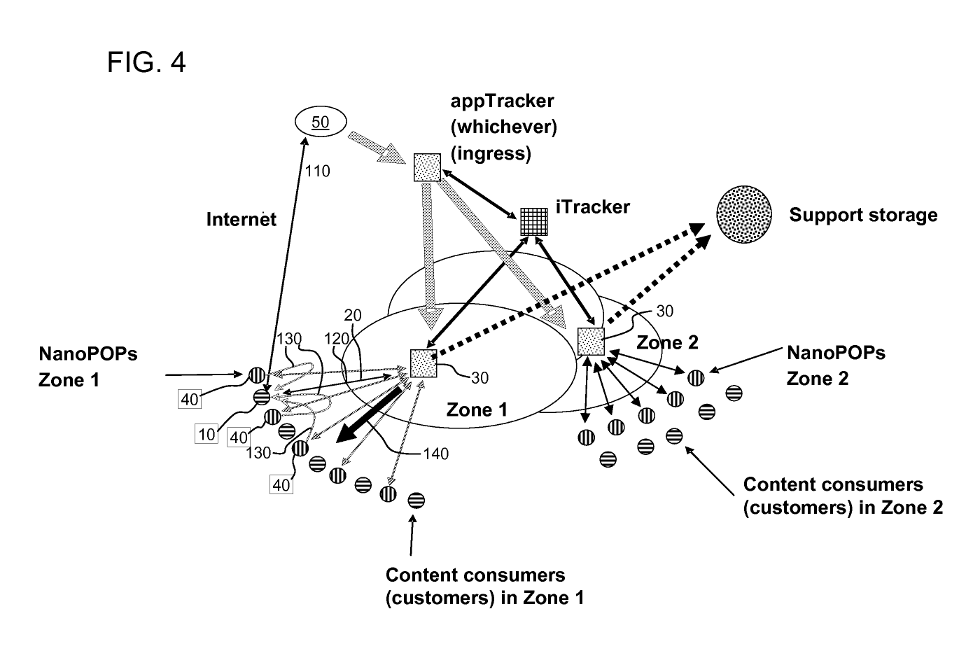

With reference to FIG. 4, a broadband customer 10 in Zone 1 requests content via a URL (step 110). The DNS 20 in Zone 1 redirects the URL to the appTracker 30 in Zone 1 (step 120). The appTracker 30 in Zone 1 coordinates the delivery of content to the consumer 20 by several dedicated storage and uplink capabilities (nanoPOPs) 40 in Zone 1 (step 130). Simultaneously, other CDN resources (latent upstream, seeding, edge content storage (CPE use) and distribution, wide geographical availability, Web servers, streaming servers, and the dedicated storage devices used to ensure availability) are used to ensure QoS (step 140). Broadband customers also participate in content distribution while downloading.

CPE Use:

Some types of CPEs (for example, PCs) need active participation of the end user. In these cases, the end user can be rewarded/compensated, for example, by receiving some content for free, receiving increased bandwidth for free, discounts, etc. These CPEs can also be used to fulfill computing tasks, thus providing cloud services in conjunction with the underlying CDN.

Seeding:

A CDN deals with content, a CDN delivers content, and the CDN deals with information taken from the environment to move content around. The “information” available includes but is not limited to: position of endpoints (that is, storage nodes at the edge of the CDN, whether ISP nodes, CPEs, or mobile devices), workload of links, workload of endpoints, pricing of content, time limits to distribution, geographic limits to distribution, network costs.

Content distribution can be thought of as a two phase process. In the first phase, the CDN is “seeded,” that is, the content is preloaded into the CDN nodes (either network nodes or CPEs) so they become available, using “strategies” designed to minimize network costs (resources used) while maximizing quality of service. A “strategy” for the CDN is a collection of decision-making criteria that take as input all the available environment information above-mentioned and give as output a collection of commands and parameters to these commands that shape the distribution process. These commands and parameters include but are not limited to: peering set for a given content and a given peer, election of service nodes, election of links to traverse, election of nodes to seed content, election of the precise moments to perform actions (seeding, reporting, etc.).

In the second phase, the content is distributed from these nodes to the broadband customers, using, for example, the advanced algorithms disclosed in International Application No. PCT/EP2009/059497, as discussed in greater detail hereinafter.

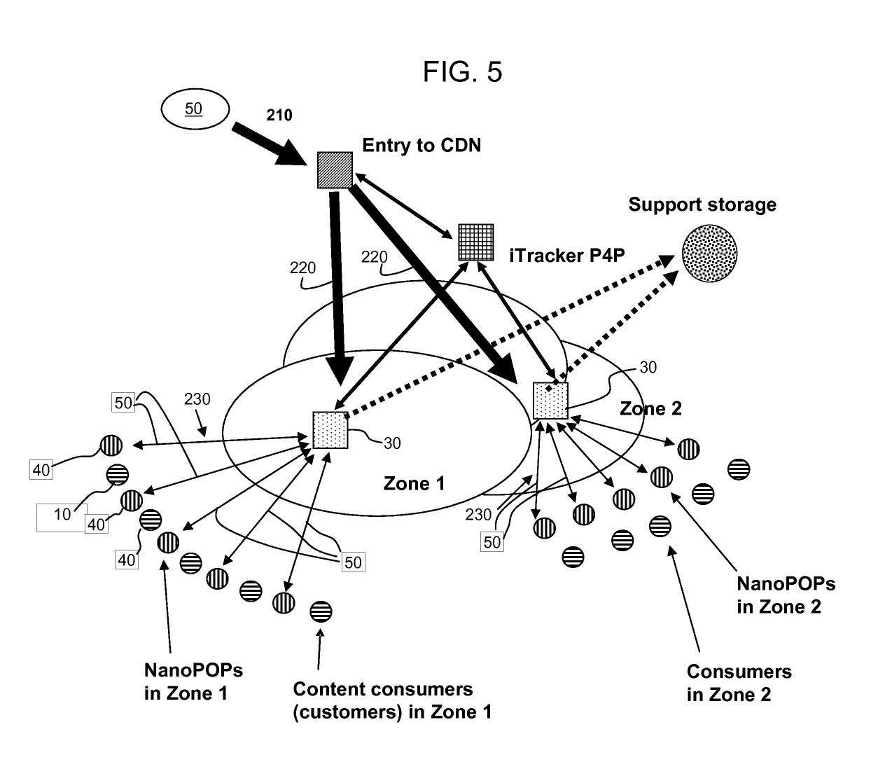

Seeding is illustrated in FIG. 5, and is done at the CPE level. A broadband customer may not always be a consumer of content alone. From time-to-time, a broadband customer's CPE will be required to seed content as well. The algorithms used to perform seeding are conventional. Seeding a file from one node to many can be done “conventionally” in many ways, including, but not limited to: (1) using the whole list of network nodes to command transferences from the source node to the rest of the network nodes, (2) using the source to store a reference to the content and to itself (the source node) in the tracker and to leave a “suggestion” so other nodes will ask for this content when they connect to the tracker, (3) using the tracker to store a reference to the source node and to publish this reference to a given subset (that is, not all) of the nodes to control spreading, (4) using the tracker to store a reference to the content and a Time To Live value so the nodes requesting this content will stop making requests after completion of the TTL, (5) using the source node to send the content to a list of neighbor nodes and a request to proceed with propagation. Seeding is performed in an intelligent manner, using strategies that take into account forecasts for content demand and end user profiling information. These strategies can be thought of as algorithms that apply the knowledge about demand and user profile to the process of deciding where (that is, which specific nodes in the CDN that will receive the content) and when (that is, the specific moment in time) to seed a specific file. AppTrackers employ these strategies to distribute seeds to the population of nodes.

There must be at least one seed in order to ensure the availability of the digital asset (which can be content, or a program (software), or a database, or other sets of bits that are not considered as “content”, for example, update patches distributed by a software company or a government tax agency distributing a computer program that helps taxpayers prepare their tax returns). The centralized decision maker (appTracker) determines where to seed the content and how many seeds are required, depending on the number of broadband customers who are consuming content at the same time (and who thus must be connected to the CDN requesting the content), the geographical distribution of the requested content, and the QoS contracted by the content provider buying CDN services (as determined by the SLA between the content provider and the ISP), and the redundancy and throughput required to ensure this QoS. A tracker can seed a sufficient number of clients to ensure redundancy.

If a broadband customer's CPE, or any other endpoint is selected for seeding, the appTracker seeds in the following way:

(1) The appTracker maintains some list of commands in a virtual output tray per endpoint registered. Seeding starts by applying the environment information through the algorithms that implement the seeding strategies, selecting the targets for seeding and then filling the “output trays” of the endpoints with the seeding command.

(2) The endpoints (CPE or not) report their state periodically to the appTracker. At the moment of report, the appTracker responds to the endpoint with the commands stored in the virtual output tray for that endpoint. These commands include but are not limited to “command the endpoint to get content file X from URL U, where U is the source endpoint.”

In carrying out the above-described process, content files should be uniquely identified in the CDN content space, so any content that enters the CDN is given a unique ID by the entry point in the CDN. This entry point is simply a Web portal.

There is a statistics module in the appTracker that keeps record of aggregated actions performed by endpoints. The action records are obtained from reports. Data from this statistics module can be used to refine a seeding process, as well as for reports intended for humans.

With reference to FIG. 5, the content provider 50 requests CDN capabilities (step 210). The CDN maps content distribution 60 according to Content Provider QoS and geographic needs (step 220). The CDN slices, encrypts, and pushes content to dedicated storage capabilities (nanoPOPs) 40 (step 230).

Granular QoS:

An appTracker monitors the performance of clients and depending on the geography of the area served, the popularity of content, and the QoS (including such parameters as latency, throughput) experienced by the clients being served, can try to ensure that a client finds healthy neighborhoods from which to quickly download the requested content. To this end, the appTracker can seed new clients in the neighborhood of a currently served client, if necessary, to ensure good latency and throughput (among other QoS parameters). By making new (if necessary), healthy neighborhoods available, the appTracker ensures QoS for individual clients.

The algorithms for seeding new clients in the neighborhood of a currently served client preferably are the Smart Neighborhood Selection (SNS) and the History-based Neighborhood Selection (HNS) algorithms disclosed in International Application No. PCT/EP2009/059497, filed Jul. 23, 2009, which is incorporated herein by reference in its entirety. As will be appreciated by those of ordinary skill in the art, it is possible to use other algorithms, for example, the Random Neighbor Selection and Optimal Neighbor Selection algorithms described in the “State of the Art” section of International Application No. PCT/EP2009/059497, as well as other algorithms, but it is expected that the SNS and HNS algorithms will be used the most.

Granular QoS is achieved by using all the aforementioned elements (latent upstream, seeding, edge content storage (CPE use) and distribution, and wide geographical availability) in conjunction with each other. With these elements, the method in accordance with the present invention can provide the equivalent of latency and throughput, in terms of seeds available and geographical distribution of these seeds or other indicators that may be considered appropriate. These Qualities of Service go from “Best Effort” (i.e. the CDN client itself hosts the seed or seeds (here “client” refers to the content provider buying CDN services)) to whatever number of seeds may be requested. As P2P scales very well, the more popular content is, the fewer seeds may be needed.

It is to be understood that the present invention is not limited to the illustrated user interfaces or to the order of the user interfaces described herein. Various types and styles of user interfaces may be used in accordance with the present invention without limitation.

Other Implementation Details

1. Terms

The detailed description contained herein is represented partly in terms of processes and symbolic representations of operations by a conventional computer. The processes and operations performed by the computer include the manipulation of signals by a processor and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure.

A “data packet” is a type of data structure having one or more related fields, which are collectively defined as a unit of information transmitted from one device or program module to another. Thus, the symbolic representations of operations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as issuing, sending, altering, adding, disabling, determining, comparing, reporting, and the like, which are often associated with manual operations performed by a human operator. The operations described herein are machine operations performed in conjunction with various inputs provided by a human operator or user that interacts with the computer.

2. Hardware

It should be understood that the programs, processes, methods, etc. described herein are not related or limited to any particular computer or apparatus, nor are they related or limited to any particular communication architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

3. Program

In the preferred embodiment, the steps of the present invention are embodied in machine-executable instructions. The instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. No particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

4. Product

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

5. Components

The major components (also interchangeably called aspects, subsystems, modules, functions, services) of the system and method of the invention, and examples of advantages they provide, are described herein with reference to the figures. For figures including process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein. However, the invention also includes any new, unconventional implementation means.

6. Web Design

Any web site aspects/implementations of the system include conventional web site development considerations known to experienced web site developers. Such considerations include content, content clearing, presentation of content, architecture, database linking, external web site linking, number of pages, overall size and storage requirements, maintainability, access speed, use of graphics, choice of metatags to facilitate hits, privacy considerations, and disclaimers.

Modifications and variations of the above-described embodiments of the present invention are possible, as appreciated by those skilled in the art in light of the above teachings. It is therefore to be understood that, within the scope of the appended claims and their equivalents, the invention may be practiced otherwise than as specifically described.

What is claimed is:

1. A method of providing granular quality of service in a content distribution network to a content provider and to broadband customers consuming the content, wherein the content distribution network includes a plurality of servers and a plurality of network nodes and has an edge, wherein the servers account for and coordinate resources of the content distribution network, wherein the network nodes are registered with and finely distributed at the edge of the content distribution network, wherein content is seeded at and distributed from the network nodes at the edge of the content distribution network via bandwidth provided by an Internet Service Provider, and wherein the network nodes can be at the premises of broadband subscribers, the method comprising the steps of:
maintaining a list of commands in a virtual output tray for each of the network nodes at the edge of the content distribution network;
applying algorithms to information about the environment of the content distribution network, wherein the algorithms implement seeding strategies that maximize utilization of resources and minimize network transactions and aggregated throughput needed;
using the results of the algorithms to select network nodes for seeding;
storing seeding commands in the virtual output trays of the selected network nodes;
receiving a periodic report at the server from each of the selected network nodes;
responding to receipt of a report from one of the selected network nodes with the commands stored in the virtual output tray for the one selected network node, wherein the commands include a command to the selected one storage node to get a specified, uniquely-identified content file from the URL of a source network node at which content is stored.

2. The method of claim 1, wherein in the information from the environment includes forecasts for content demand in some zones and forecasts about and knowledge of end users of content.

3. A system of providing granular quality of service in a content distribution network having an edge, comprising:
a plurality of storage nodes finely distributed across a plurality of network nodes at the edge of the content distribution network, wherein content is seeded at and distributed from the plurality of storage nodes, and wherein the network nodes can be at the premises of broadband subscribers;
means implemented by at least one server for determining where to seed digital content and how many seeds are required, based on the number of clients requesting the content, the geography of the requested content, the quality of service contracted by the CDN client and the redundancy and throughput required to ensure the contracted quality of service; and
means implemented by at least one server for enforcing seeding of CPEs designated to be seeded for content via at least one of: (1) periodic reporting of the storage nodes to the at least one server, (2) unique IDs assigned to the content and content hashes, and (3) book-keeping statistics collected from the seeds.

4. The system of claim 3, wherein the means for enforcing of seeding also collects book-keeping information for a subset of broadband customers at periodic intervals to confirm that downloads are occurring from the seed.
